(19) United States
(12) Patent Application Publication
(10) Pub. No.: US 2023/0030599 A1
(43) Pub. Date: Feb. 2, 2023

(54) CONTAINER LOADING PLANNING DEVICE, METHOD, AND PROGRAM

(71) Applicant: NEC Corporation, Minato-ku, Tokyo (JP)

(72) Inventor: Ryota HIGA, Tokyo (JP)

(73) Assignee: NEC Corporation, Minato-ku, Tokyo (JP)

(21) Appl. No.: 17/791,066

(22) PCT Filed: Jan. 20, 2020
(86) PCT No.: PCT/JP2020/001759

§ 371 Date: Jul. 6, 2022

(51) Int. Cl. G06Q 10/08; G06Q 10/06

(52) U.S. Cl. CPC G06Q 10/08; G06Q 10/06315

(57) ABSTRACT

An input unit 81 receives an input of information on a container to be loaded, loading status of a freight car, and a container arrival prediction. A loading position determination unit 82 determines a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car. And the loading position determination unit 82 determines the loading position of the container based on the value function calculated based on the container arrival prediction and the policy function.

### TECHNICAL FIELD

The present invention relates to a container loading planning device, a container loading planning method, and a container loading planning program for planning a position of a container to be loaded on a freight car.

### BACKGROUND ART

In recent years, with the development of AI (Artificial Intelligence) and IoT (Internet of Things), there is also a need for operational efficiency and automation in the logistics industry. Rail cargo transportation is another form of transportation in the logistics industry, and the management of containers used for the rail cargo transportation also requires greater efficiency.

An example of a system for managing containers is described in Non-Patent Literature 1. The system described in Non-Patent Literature 1 maneuvers and distributes containers appropriately by grasping the container's position, etc. in real time. The system described in Non-Patent Literature 1 has an automatic slot adjustment function, which automatically reserves the earliest arriving train and changes the spare cargo to other trains whenever a new cargo order is received.

### CITATION LIST

### Non-Patent Literature

Toshiki Hanaoka, “Freight Railway Container Management System Using RFID,” Journal of the Institute of Electrical Installation Engineers of Japan, Inc., 2008, Vol. 28, No. 5, pp. 311-315.

### SUMMARY OF INVENTION

### Technical Problem

On the other hand, the system described in Non-patent Literature 1 does not take into account constraints during loading, such as container loading balance. In addition, at actual loading sites, there are cases where changes in reservations, etc. may occur. However, the system described in Non-Patent Literature 1 is a static system that does not consider sequential changes in the current situation, so it is unable to respond to such changes, and the system is corrected accordingly based on on-site judgment. Therefore, there is a problem that the loading efficiency differs depending on the skill level of the operator who handles the problem.

In addition, simply trying to optimize the combination of possible container patterns would result in a combinatorial explosion, which would be difficult to handle in realistic time when trying to plan loading positions in real time on site.

Therefore, it is an exemplary object of the present invention to provide a container loading planning device, a container loading planning method, and a container loading planning program that can plan efficient container loading positions in real time.

### Solution to Problem

A container loading planning device according to the exemplary aspect of the present invention includes: an input unit which receives an input of information on a container to be loaded, loading status of a freight car, and a container arrival prediction; and a loading position determination unit which determines a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car, wherein the loading position determination unit determines the loading position of the container based on the value function calculated based on the container arrival prediction and the policy function.

A container loading planning method according to the exemplary aspect of the present invention includes: receiving an input of information on a container to be loaded, loading status of a freight car, and a container arrival prediction; determining a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car; and in determining the loading position of the container, the loading position of the container is determined based on the value function calculated based on the container arrival prediction and the policy function.

A appearance inspection program according to the exemplary aspect of the present invention causes a computer to execute: an input process of receiving an input of information on a container to be loaded, loading status of a freight car, and a container arrival prediction; and a loading position determination process of determining a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car, wherein the loading position of the container is determined based on the value function calculated based on the container arrival prediction and the policy function, in the loading position determination process.

### Advantageous Effects of Invention

According to the exemplary aspect of the present invention, it is possible to plan efficient container loading positions in real time.

### BRIEF DESCRIPTION OF DRAWINGS

FIG. 1 It depicts a block diagram showing a configuration example of an exemplary embodiment of a container loading planning device according to the present invention.

FIG. 2 It depicts an explanatory diagram showing a policy function.

FIG. 3 It depicts an explanatory diagram showing an example of the process for determining a loading position of a container.

FIG. 4 It depicts an explanatory diagram showing an example of node selection by look-ahead.

FIG. 5 It depicts an explanatory diagram showing an example of a process of adding a node.

FIG. 6 It depicts an explanatory diagram showing an example of a process of calculating the sum of values calculated at each node.

FIG. 7 It depicts an explanatory diagram showing an example of the results of a simulation run.

FIG. 8 It depicts an explanatory diagram showing an example of the output of trial results.

FIG. 9 It depicts a flowchart showing an example of the operation of the container loading planning device.

FIG. 10 It depicts a block diagram showing an overview of the container loading planning device according to the present invention.

FIG. 11 It depicts a schematic block diagram showing a structure of a computer for at least one exemplary embodiment.

### DESCRIPTION OF EMBODIMENTS

Hereinafter, an exemplary embodiment of the present invention will be described with reference to the drawings.

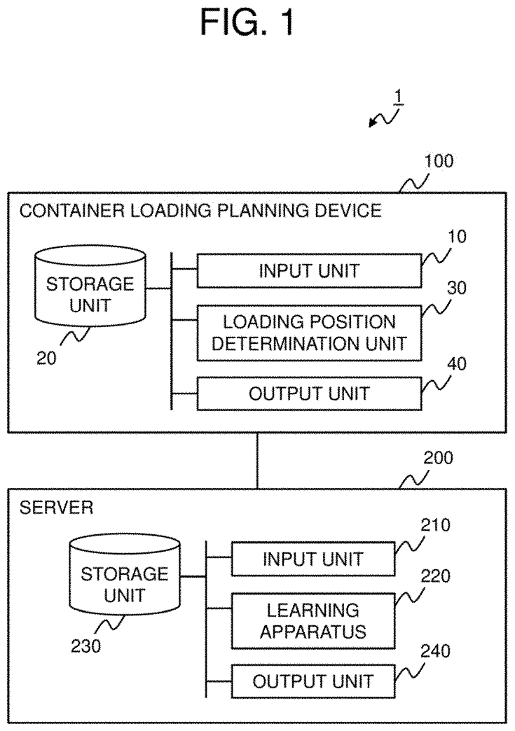

FIG. 1 is a block diagram showing a configuration example of an exemplary embodiment of a container loading planning device according to the present invention. A container loading planning device 100 of this exemplary embodiment includes an input unit 10, a storage unit 20, a loading position determination unit 30, and an output unit 40.

As illustrated in FIG. 1, the container loading planning device 100 of this exemplary embodiment is connected to a server 200, and an entire system may be realized as a container loading planning system 1.

The input unit 10 receives an input of information on a container to be loaded and loading status of a freight car. The information on a container to be loaded means information on containers to be loaded on the freight car, including, for example, the length of containers and whether they are loaded with or without cargo. The loading status of the freight car indicates where the container is positioned in the overall freight car of the target.

In this exemplary embodiment, for simplicity of explanation, it is assumed three types of containers (12-feet container, 20-feet container, and 30-feet container), a situation with or without cargo in each container. The loading status of the freight car is identified by the following numbers.
0: No container placement
1: 12-feet container placement
2: Empty 12-feet container placement
3: 20-feet container placement
4: Empty 20-feet container placement
5: 30-feet container placement
6: Empty 30-feet container placement

Let N denote the loading position of each freight car and N′ denote the number of the freight car, then the state set

### [Math. 1]

[symbol]

is expressed as follows.

s ∈ {0, 1, 2, 3, 4, 5, 6}^{N×N′}

For example, if there are 5 different loading positions for freight cars and about 24-26 freight cars, the number of states is 7¹³⁰≈10¹¹⁰. Even with this simplification, the number of combinations can be said to be enormous.

In addition, the input unit 10 receives an input of a container arrival prediction. The container arrival prediction is information indicating containers scheduled to arrive after the container to be loaded (including containers with confirmed arrivals). The container arrival prediction may include information on containers to be loaded.

The manner in which container arrival predictions are represented is arbitrary. For example, the container arrival prediction may be information that represents the specific container that is scheduled to arrive (to be loaded). Alternatively, the container arrival prediction may be information that allows sampling of containers from a predicted distribution of arrival probabilities (weights) for each container type.

For example, when the state of the container scheduled to arrive is s′, and it is assumed that h can be read ahead, the state sₜ′ at time t can be expressed as follows. The following state sₜ′ may be generated from the probability distribution p_{θb} (s′) of the container arrival prediction.

sₜ′ ∈ {0, 1, 2, 3, 4, 5, 6}^{h}

The storage unit 20 stores various information used by the loading position determination unit 30, described below, to determine the loading position of containers. In this exemplary embodiment, the storage unit 20 stores a policy function and a value function. The value function V_{θ}(s) is a function that calculates the value (evaluation value) for the loading status s of a freight car. For example, in the case of a container loading, the value function can be defined as a function that calculates a ratio of the container loading capacity to the maximum loading capacity (length of the freight car).

Specifically, it is assumed that the reward function for whether it could be loaded or not is rₜ∈ {0, 1}, the weight (container feet loaded) is wₜ ∈ {12, 20, 30}, the number of loading positions is N (=5), and the number of freight cars is N′ (=26), the value function V_{d}(s) can be expressed in Equation 1 below. The value function may be defined simply as a function that takes 1 if the stacking is successful in the final state and 0 if the stacking fails.

$$\begin{matrix}[ Math . 2 ] & \\ {V}_{d} ( s ) := \frac{{\sum }_{t = 1}^{H} {w}_{t} {r}_{t}}{12 \times N \times {N}^{′}} & ( Equation 1 )\end{matrix}$$

The policy function π(aₜ|sₜ) is a function that calculates a selection probability (probability of a next action) of the loading position of a container assumed for the loading state sₜ of a freight car. In the case of the container loading, the selection made here is the action at of sequentially placing containers among N×N′ possible positions at time t.

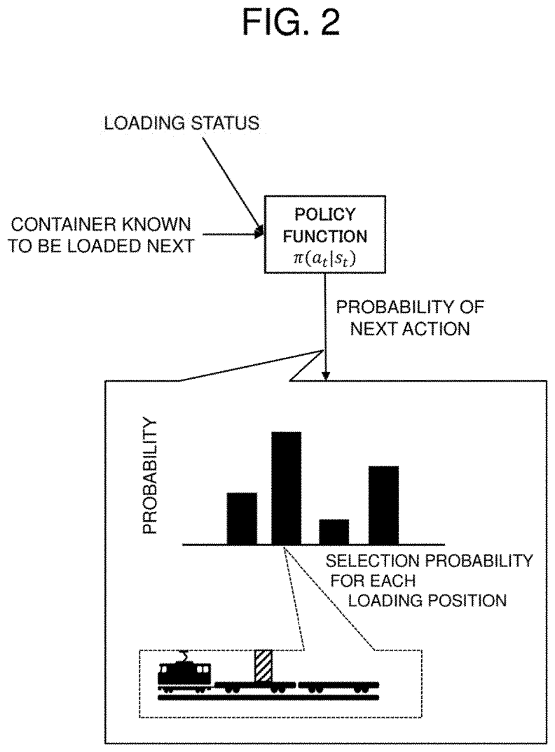

FIG. 2 is an example of a policy function. As illustrated in FIG. 2, the policy function π(aₜ|sₜ) takes as input the loading state of the freight car and information on the container known to be loaded next (container to be loaded) and outputs the probability of the next action (that is, the selection probability of each loading position in a given state s).

The policy function and the value function may be learned using training data indicating past loading result or loading plans. Here, the loading plan means information indicating the loading position of containers determined by the loading position determination unit 30 described below. The learning method of the policy function and the value function is arbitrary. For example, the policy function and the value function may be learned using a learning apparatus that performs deep learning. In the example illustrated in FIG. 1, the policy function and the value function learned by the learning apparatus 220 of the server 200 may be used.

The loading position determination unit 30 determines the loading position of the container to be loaded on the freight car based on the policy function and value function. In particular, in this exemplary embodiment, the loading position determination unit 30 determines the loading position of the container based on the value function calculated based on the container arrival prediction and the policy function.

Note that even if evaluation (optimization) were to be performed for all possible branches based on the loading status of all freight cars, the number of combinations would be enormous, and it would be difficult to perform the process in real time. Therefore, in this exemplary embodiment, the loading position determination unit 30 uses Monte Carlo tree search to determine the loading position of containers in order to concentrate the search for effective methods through simulation.

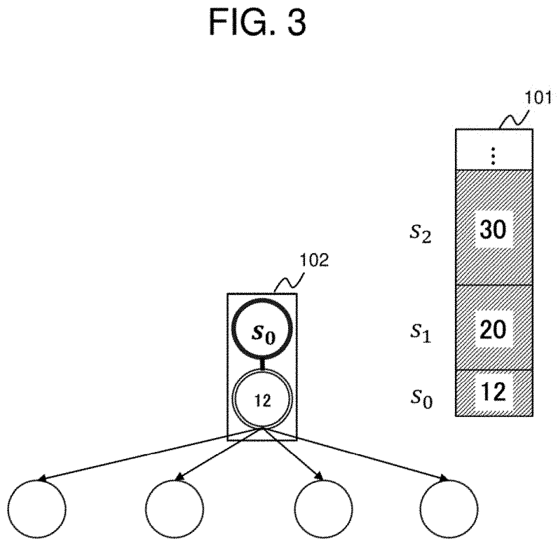

Here is a specific example of using Monte Carlo tree search to determine the loading position of a container. FIG. 3 is an example of the process for determining the loading position of a container. In this specific example, the initial state of the freight car is so, and the container states predicted thereafter are s₁, s₂ . . . . In the example illustrated in FIG. 3, it is assumed that, based on the container arrival prediction 101, the container to be loaded in the initial state so is “12 feet container”, the container expected to be placed in the next state s₁ is a “20 feet container”, and the container expected to be placed in the next state s₂ is a “30 feet container”.

Each node in the Monte Carlo tree corresponds to a loading position (i.e., which wagons are loaded at which location). As illustrated in FIG. 3, in the initial state so, only the root node 102 exists. The loading position determination unit 30 determines the loading position of the container by repeating the trials in the order of arrival of the containers indicated by the container arrival prediction. In doing so, the loading position determination unit 30 repeats the trials to select the loading position of the container that maximizes the value of a selection criterion of the node in the Monte Carlo tree containing the value function and the policy function. Then, the loading position determination unit 30 determines the loading position indicated by the node with the highest number of trials as the loading position of the container.

This selection criterion is defined by considering the trade-off between evaluation based on a look-ahead, which is based on the container arrival prediction, and evaluation based on the probability of decision-making. Here, the probability of decision-making can be calculated based on the policy function, and the evaluation based on a look-ahead can be calculated by the sum of the value functions calculated when following the look-ahead.

Therefore, the loading position determination unit 30 may repeat the trial to select the node with the largest value of the selection criterion X(s, a) defined by Equation 2 below. In Equation 2, W(s) indicates the sum of the values of the value function V_{θ}(s) calculated at each node under the node, and N(s, a) indicates the number of selections (number of trials) for that node. In the case when the freight car to be selected is a₁ and the loading position of the freight car is a₂, then the loading position is a=(a₁, a₂).

$$\begin{matrix}[ Math . 3 ] & \\ X ( s , a ) := \frac{W ( s )}{N ( s , a )} + c {π}_{θ} ( a \vert s ) \frac{\sqrt{{\sum }_{b} N ( s , b )}}{N ( s , a ) + 1} & ( Equation 2 )\end{matrix}$$

The selection criterion illustrated in Equation 2 above can be said to be a criterion defined in such a way that the value of the value function and the value of the policy function are reduced for nodes with a higher number of trials.

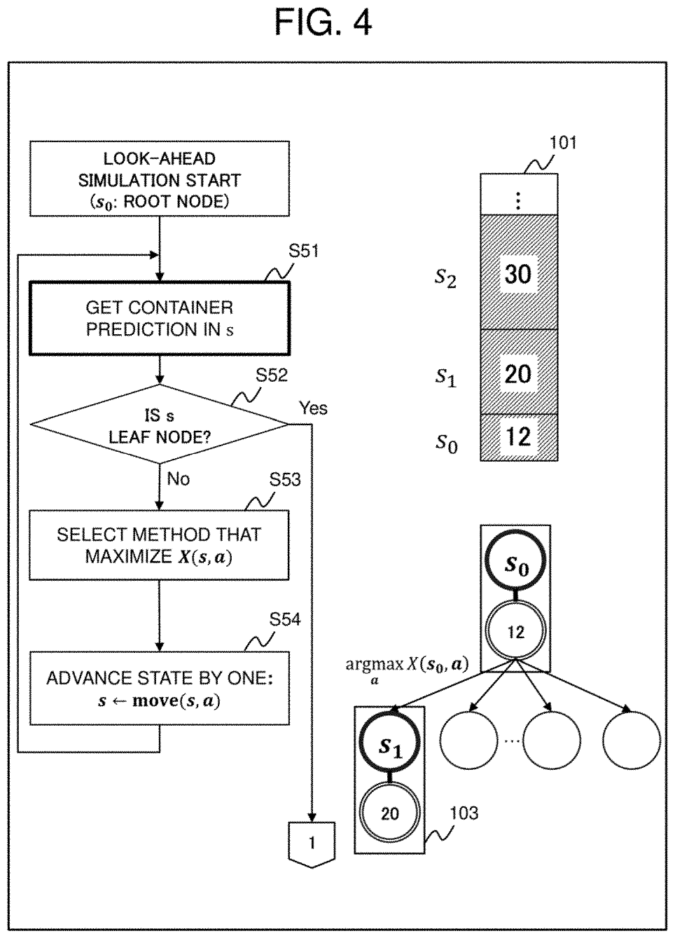

The following is a specific description of the attempts made based on the conditions illustrated in FIG. 3. FIG. 4 is an example of node selection based on look-ahead. First, the loading position determination unit 30 obtains information on containers that are expected to be placed in state s from the container arrival prediction (step S51). In the initial state so, the loading position determination unit 30 obtains information on the container (20-feet container) that is expected to be placed in state s₁.

Next, the loading position determination unit 30 determines whether the current state s is a leaf node or not (step S52). Here, since so is not a leaf node (i.e., No in step S52), it is proceeded to step S53.

In step S53, the loading position determination unit 30 selects the node with the largest selection criterion X(s, a). In the initial state so, no node has yet made a trial, so it is assumed that the first loading position 103 of the first freight car (a=(1, 1)) is selected in state s₁. After that, the loading position determination unit 30 advances the state by one (step S54), and then it is proceeded to step S51.

The loading position determination unit 30 again obtains information on the containers that are expected to be placed in state s from the container arrival prediction (step S51). In the state s₁, the loading position determination unit 30 obtains information on the container (30-feet container) that is predicted to be placed in state s₂.

Next, the loading position determination unit 30 determines whether the current state s is a leaf node or not (step S52). Here, s₁ is a leaf node (i.e., Yes in step S52), so it is proceeded to the process of adding a node.

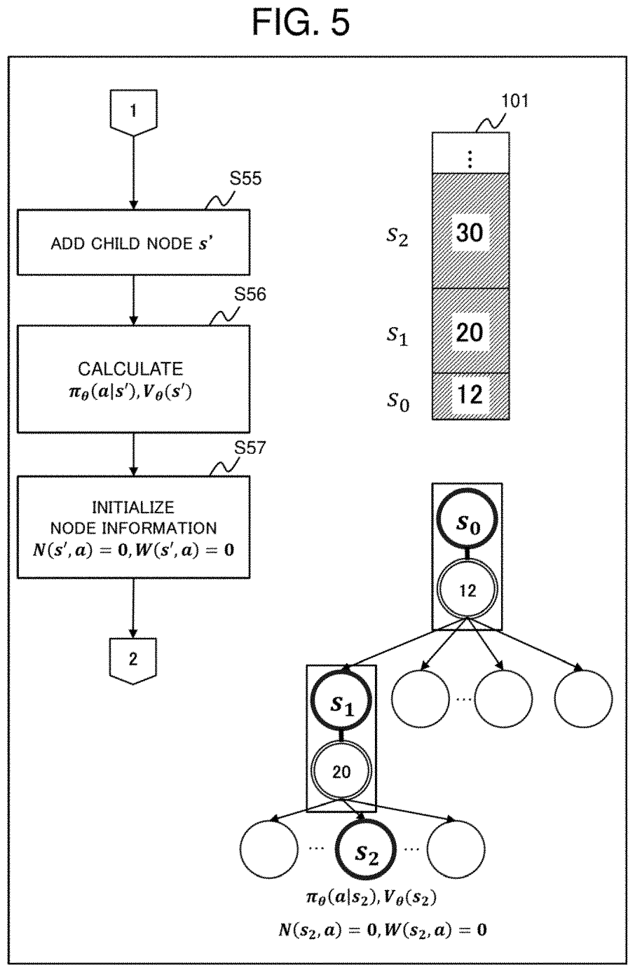

FIG. 5 is an example of the process of adding a node. The loading position determination unit 30 adds a child node s′ to the current node (step S55). Then, for the state s′ of the added child node (in this case, s₂), the loading position determination unit 30 determines the policy function for each candidate loading position (π_{θ}(a|s′)) and value function (V_{θ}(s′)) (step S56). The loading position determination unit 30 also initializes the information of each added node (step S57). That is, for each loading position, the loading position determination unit 30 initializes N (s′, a)=0 and W (s′, a).

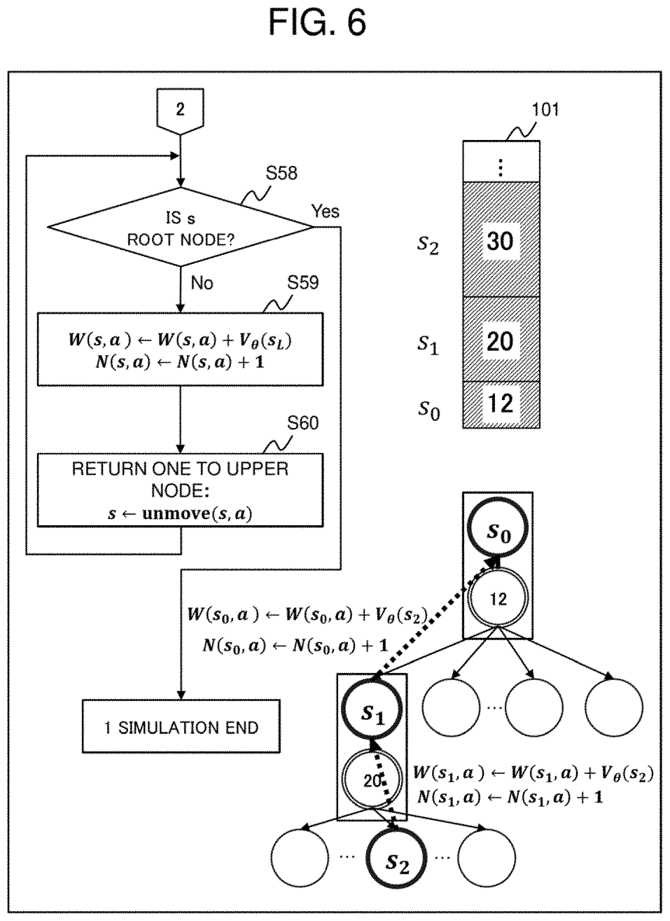

FIG. 6 is an example of the process of calculating the sum of values calculated at each node under the node. The process illustrated in FIG. 6 shows the process of propagating the value function of a leaf node in reverse. First, the loading position determination unit 30 determines whether the current state s is the root node or not (step S58). Since state s₂ is not a root node (No in step S58), then it is proceeded to step S59.

In step S59, the loading position determination unit 30 adds the value s_{L} (here, V_{θ}(s₂)) of the value function calculated in the state of the leaf node (here, s₂) to the sum W(s,a) of the value functions of the upper node (here, s₁), and updates the sum (here, W (s₁, a)). In addition, the loading position determination unit 30 adds 1 to the selection count N (s, a) of the upper node (here, s₁) and updates the sum (here, N (s₁, a)) (step S59). Then, the loading position determination unit 30 then returns the process to the upper node (step S60).

The process is then repeated from step S58 onward. Specifically, the loading position determination unit 30 determines whether the current state s is a root node or not (step S58). Since state s₁ is not a root node (No in step S58), then it is proceeded to step S59.

In step S59, the loading position determination unit 30 adds the value s_{L} (here, V_{θ}(s₂)) of the value function calculated in the state of the leaf node (here, s₂) to the sum W(s,a) of the value functions of the upper node (here, s₀), and updates the sum (here, W (s₀, a)). In addition, the loading position determination unit 30 adds 1 to the selection count N (s, a) of the upper node (here, s₀) and updates the sum (here, N (s₀, a)) (step S59). Then, the loading position determination unit 30 then returns the process to the upper node (step S60).

The process is then repeated from step S58 onward. Specifically, the loading position determination unit 30 determines whether the current state s is a root node or not (step S58). Since state s₀ is not a root node (Yes in step S58), then the process is terminated.

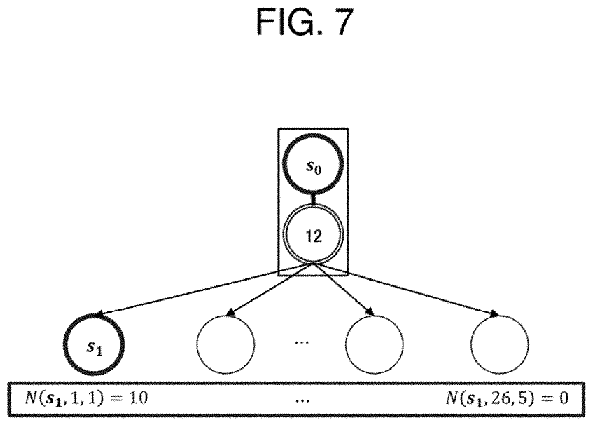

By running this simulation multiple times, the loading position determination unit 30 can obtain the number of trials N (s, a) for each node (loading position). FIG. 7 is an example of the results of a simulation run. The example illustrated in FIG. 7 indicates that 100 simulation runs resulted in at least 10 attempts at the first loading position of the first freight car (a=(1, 1)).

The loading position determination unit 30 may also calculate the policy distribution using the Boltzmann distribution based on the trial results. Specifically, the loading position determination unit 30 may calculate the policy distribution based on Equation 3 shown below. In Equation 3, N (s, a) is the number of trials performed in state s, and β is the inverse temperature. β may be set arbitrarily, and when determining the optimal loading position, it should be set to β⁻¹=0. This corresponds to argmaxₐπ(a|s).

$$\begin{matrix}[ Math . 4 ] & \\ {π}_{β} ( a \vert s ) := \frac{{N}^{β} ( s , a )}{{\sum }_{{a}^{′}} N β ( s , {a}^{′} )} & ( Equation 3 )\end{matrix}$$

When the number of simulations is L, the loading position determination unit 30 may calculate the policy distribution by considering the constraints illustrated in Equation 4 below.

$$\begin{matrix}[ Math . 5 ] & \\ {\sum }_{a} N ( {s}_{1} , a ) \leq L & ( Equation 4 )\end{matrix}$$

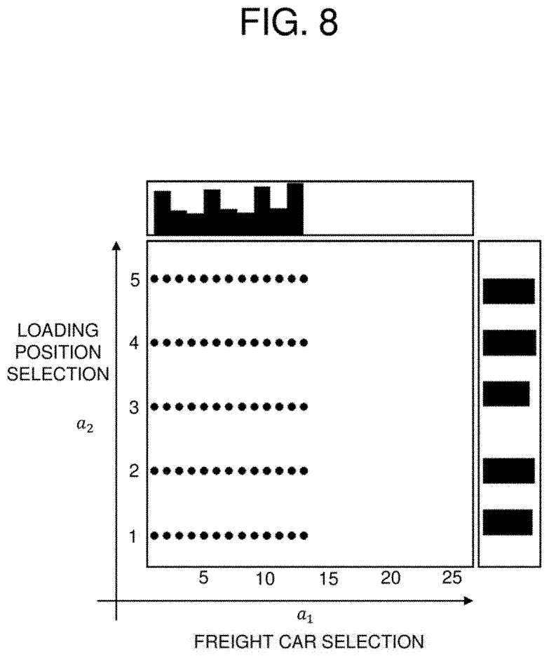

The output unit 40 outputs the determined container loading position. The output unit 40 may also output information about the freight cars and loading positions selected in the trial as the trial results. FIG. 8 is an illustration of an example of the output of trial results. The example illustrated in FIG. 8 shows a graph with the number of the selected freight car a₁ set on the horizontal axis and the selected loading position az in the freight car on the vertical axis. In the example illustrated in FIG. 8, the number of times selected for each freight car and the number of times selected for each loading position are shown as bar graphs in the upper part of the graph and in the right part of the graph, respectively, and the selected loading position is indicated by a circle in the graph.

The input unit 10, the loading position determination unit 30, and the output unit 40 are realized by a computer processor (for example, a central processing unit (CPU), a graphics processing unit (GPU)) that operates according to a program (container loading planning program). The storage unit 20 is realized by, for example, a magnetic disk.

For example, a program may be stored in the storage unit 20 provided by the container loading planning device 100, and the processor may read the program and operate as the input unit 10, the loading position determination unit 30, and the output unit 40 according to the program. The functions of the container loading planning device 100 may be provided in a SaaS (Software as a Service) format.

The input unit 10, the loading position determination unit 30, and the output unit 40 may each be realized by dedicated hardware. In addition, some or all of the components of each device may be realized by general purpose or dedicated circuits, a processor, or combinations thereof. These may be configured by a single chip or by multiple chips connected via a bus. Some or all of the components of each device may be realized by a combination of the above-mentioned circuits, etc. and programs.

Further, when some or all of the components of the container loading planning device 100 are realized by multiple information processing devices, circuits, etc., the multiple information processing devices, circuits, etc. may be centrally located or distributed. For example, the information processing devices, circuits, etc. may be realized as a client server system, a cloud computing system, etc., each of which is connected via a communication network.

In FIG. 1, the server 200 is a device for learning value function and policy function, and includes an input unit 210, a learning apparatus 220, a storage unit 230, and an output unit 240.

The input unit 210 accepts input of training data indicating past loading results or loading plans to be used for learning. The input unit 210 may also store the accepted training data in the storage unit 230.

The learning apparatus 220 learns value function and the policy function by machine learning using accepted training data. The learning method used by the learning apparatus 220 is arbitrary. For example, the value function and the policy function may be learned by widely known deep learning.

The storage unit 230 stores the generated value function and the policy function. The storage unit 230 may also store accepted training data. The storage unit 230 is realized by, for example, a magnetic disk.

The output unit 240 outputs the generated value function and the policy function. The output unit 240 may transmit the generated value function and the policy function to the container loading planning device 100 and store the storage unit 20.

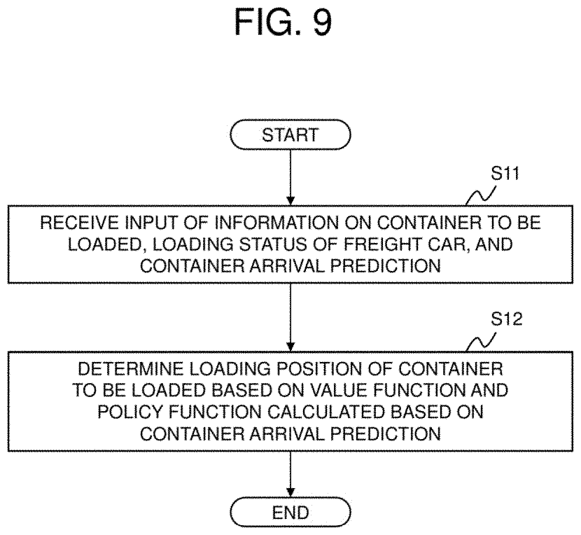

Next, a description will be given of an operation of the container loading planning equipment 100 of the present exemplary embodiment. FIG. 9 is a flowchart showing an example of the operation of the container loading planning device 100 according to the present exemplary embodiment. The input unit 10 receives inputs of information on containers to be loaded, loading status of a freight car, and a container arrival prediction (step S11). The loading position determination unit 30 determines a loading position of the container to be loaded based on the value function and policy function calculated based on the container arrival prediction (step S12).

As described above, in this exemplary embodiment, the input unit 10 receives an input of information on containers to be loaded, loading status of freight cars, and container arrival prediction, and the loading position determination unit 30 determines a loading position of the container to be loaded on the freight car based on the policy function and the value function. In doing so, the loading position determination unit 30 determines the loading position of the container based on the value function calculated based on the container arrival prediction and the policy function. Thus, efficient container loading positions can be planned in real time, leading to stabilization of loading efficiency.

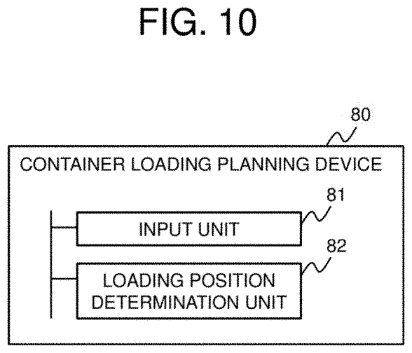

Next, an outline of the present invention will be described. FIG. 10 is a block diagram showing an overview of the container loading planning device according to the present invention. The container loading planning device 80 (e.g., the container loading planning device 100) according to the present invention includes an input unit 81 (e.g., the input unit 10) which receives an input of information on a container to be loaded, loading status of a freight car, and a container arrival prediction, and a loading position determination unit 82 (e.g., loading position determination unit 30) which determines a loading position of the container to be loaded on a freight car based on a policy function (e.g., π(aₜ|sₜ)), which is trained based on a past loading result or a loading plan, that calculates a selection probability of the loading position of the container assumed for the loading status of the freight car and a value function (e.g., V_{θ}(sₜ)) that calculates a value for the loading status of the freight car.

The loading position determination unit 82 determines the loading position of the container based on the value function calculated based on the container arrival prediction and the policy function.

Such a configuration allows efficient container loading positions to be planned in real time.

Specifically, the loading position determination unit 82 may try multiple times, by a Monte Carlo tree search (e.g., the Monte Carlo tree search illustrated in FIG. 3 through FIG. 6) where a node corresponds to the loading position of the container, to search the loading position of the container that maximizes the value of a selection criterion (e.g., Equation 2 above) of a node including the value function and the policy function in an order of arrival of the container indicated by the container arrival prediction to determine the loading position of the container.

In that case, the loading position determination unit 82 may determine the loading position corresponding to the node with the highest number of trials as the container loading position of the container.

The loading position determination unit 82 may calculate a value of a first value function by trying a node corresponding to the loading position that maximizes the value of the selection criterion for a first container predicted from the container arrival prediction, calculate a value of a second value function by trying a lower node from the node corresponding to the tried loading position for a second container predicted after the first container, and add the value of the second value function to a value of the first value function of an upper node to update the value of the first value function of the upper node.

The selection criterion may be defined such that the value of the value function is reduced and the value of the policy function is reduced for nodes with more trials.

The loading position determination unit 82 may calculate a policy distribution using Boltzmann distribution based on a trial result (e.g., Equation 3 and Equation 4 above).

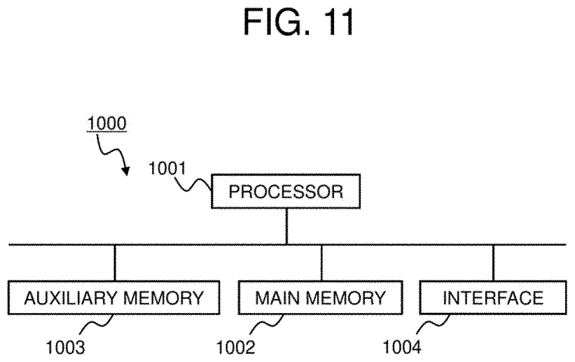

FIG. 11 is a schematic block diagram showing a structure of a computer according to aₜ least one exemplary embodiment. A computer 1000 includes a processor 1001, a main storage device 1002, an auxiliary storage device 1003, and an interface 1004.

The container loading planning device 80 described above is implemented by the computer 1000. The operation of each processing unit described above is stored in the auxiliary storage device 1003 in the form of a program (container loading planning program). The processor 1001 reads the program from the auxiliary storage device 1003, expands the program in the main storage device 1002, and executes the above-described process according to the program.

In at least one exemplary embodiment, the auxiliary storage device 1003 is an example of a non-transitory tangible medium. Examples of the non-transitory tangible medium include a magnetic disk, magneto-optical disk, CD-ROM (compact disc read-only memory), DVD-ROM (read-only memory), and semiconductor memory connected via the interface 1004. In the case where the program is distributed to the computer 1000 through a communication line, the computer 1000 to which the program has been distributed may expand the program in the main storage device 1002 and execute the above-described process.

The program may realize part of the above-described functions. The program may be a differential file (differential program) that realizes the above-described functions in combination with another program already stored in the auxiliary storage device 1003.

### REFERENCE SIGNS LIST

1 Container loading planning system
10 Input unit
20 Storage unit
30 Loading position determination unit
40 Output unit
100 Container loading planning device
200 Server
210 Input unit
220 Learning apparatus
230 Storage unit
240 Output unit

What is claimed is:

1. A container loading planning device comprising:
a memory storing instructions; and
one or more processors configured to execute the instructions to:
receive an input of information on a container to be loaded, loading status of a freight car, and a container arrival prediction; and
determine a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car,
wherein in determining the loading position of the container, the processor executes instructions to determine the loading position of the container based on the value function calculated based on the container arrival prediction and the policy function.

2. The container loading planning device according to claim 1, wherein the processor further executes instructions to
try multiple times, by a Monte Carlo tree search where a node corresponds to the loading position of the container, to search the loading position of the container that maximizes the value of a selection criterion of a node including the value function and the policy function in an order of arrival of the container indicated by the container arrival prediction to determine the loading position of the container.

3. The container loading planning device according to claim 2, wherein the processor further executes instructions to
determine the loading position corresponding to the node with the highest number of trials as the loading position of the container.

4. The container loading planning device according to claim 2, wherein the processor further executes instructions to
calculate a value of a first value function by trying a node corresponding to the loading position that maximizes the value of the selection criterion for a first container predicted from the container arrival prediction, calculate a value of a second value function by trying a lower node from the node corresponding to the tried loading position for a second container predicted after the first container, and add the value of the second value function to a value of the first value function of an upper node to update the value of the first value function of the upper node.

5. The container loading planning device according to claim 2, wherein
the selection criterion is defined such that the value of the value function is reduced and the value of the policy function is reduced for nodes with more trials.

6. The container loading planning device according to claim 1, wherein the processor further executes instructions to
calculate a policy distribution using Boltzmann distribution based on a trial result.

7. A container loading planning method comprising:
receiving an input of information on a container to be loaded, loading status of a freight car, and a container arrival prediction;
determining a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car; and
in determining the loading position of the container, the loading position of the container is determined based on the value function calculated based on the container arrival prediction and the policy function.

8. The container loading planning method according to claim 7, further comprising
trying multiple times, by a Monte Carlo tree search where a node corresponds to the loading position of the container, to search the loading position of the container that maximizes the value of the selection criterion of a node including the value function and the policy function in an order of arrival of the container indicated by the container arrival prediction to determine the loading position of the container.

9. A non-transitory computer readable information recording medium storing a container loading planning program, when executed by a processor, that performs a method for:
receiving an input of information on a container to be loaded, loading status of a freight car, and a container arrival prediction; and
determining a loading position of the container to be loaded on a freight car based on a policy function, which is trained based on a past loading result or a loading plan, that calculates a selection probability of the loading position of the container assumed for the loading status of the freight car and a value function that calculates a value for the loading status of the freight car,
wherein the loading position of the container is determined based on the value function calculated based on the container arrival prediction and the policy function.

10. The non-transitory computer readable information recording medium according to claim 9, further comprising a method for
trying multiple times, by a Monte Carlo tree search where a node corresponds to the loading position of the container, to search the loading position of the container that maximizes the value of the selection criterion of a node including the value function and the policy function in an order of arrival of the container indicated by the container arrival prediction to determine the loading position of the container, in the loading position determination process.
